(19) United States
(12) Patent Application Publication
(10) Pub. No.: US 2004/0212676 A1
(43) Pub. Date: Oct. 28, 2004

(54) Optical detection system for vehicles

(75) Inventors: Joachim Mathes, Heilbronn (DE); John Cooper, Draveil (FR)

Correspondence Address: Dreiss, Fuhlendorf, Steimle & Becker, Postfach 10 37 62, Stuttgart, D-70032, DE

(73) Assignee: Valeo Schalter und Sensoren GmbH, Bietigheim-Bissingen (DE)

(21) Appl. No.: 10/810,589

(22) Filed: Mar. 29, 2004

(30) Foreign Application Priority Data
Apr. 22, 2003 (DE) 103 21 228.0

(51) Int. Cl. H04N 7/18

(52) U.S. Cl. 348/148; 348/143

(57) ABSTRACT

The invention concerns an optical detection system (2) for vehicles, in particular motor vehicles, comprising a camera optics (4, 6) disposed on the vehicle, and a control device (8) for controlling the focus and/or image frame of the camera optics (4, 6), wherein the control device (8) is suited for coupling to a signal transmitter (34, 36, 38, 60), such that the focus and/or the image frame of the camera optics (4, 6) can be controlled in dependence on the signals which can be generated by the signal transmitter (34, 36, 38, 60). The invention also concerns a control device (8) and a method for an optical detection system (2).

This application claims Paris Convention priority of DE 103 21 228.0 filed Apr. 22, 2003 the complete disclosure of which is hereby incorporated by reference.

### BACKGROUND OF THE INVENTION

The invention relates to an optical detection system for vehicles, in particular motor vehicles, comprising a camera optics disposed on the vehicle, and a control device for controlling the focus and/or the image frame of the camera optics. The invention also relates to a method for an optical detection system.

The use of camera systems in vehicles is known in the art. Japanese motor vehicles e.g. are increasingly provided with cameras for backing up, whose focus and/or image frame cannot be varied. There are also conventional camera systems for security applications whose focus and/or image frame can be manually adjusted and which can be connected to a monitor for monitoring the surroundings of the vehicle.

On the basis of the above-mentioned prior art, it is the underlying purpose of the present invention to further develop an optical detection system for vehicles such that it can be used with greater flexibility.

### SUMMARY OF THE INVENTION

This object is achieved in that the control device can be coupled to a signal transmitter such that the focus and/or the image frame of the camera optics can be controlled in dependence on the signals generated by the signal transmitter. The signal transmitter signals can be used for optimum adjustment of the focus and/or image frame of the camera optics. This adjustment can be automatic i.e. without requiring an operator.

In accordance with a first embodiment of the invention, the signal transmitter is formed by sensors which can be disposed on the vehicle to detect persons and/or objects in the vicinity of the vehicle. Each of such signal transmitters is usually used for a separate system in the motor vehicles. Such systems may be e.g. parking assistance systems and/or distance control systems and/or lane deviation warning systems and/or night vision systems and/or systems for early detection of accident situations. The sensors for these systems which are already provided on a vehicle may also serve as a signal transmitter for the control device of the camera optics, such that the focus and/or the image frame of the camera optics can be adjusted. This link permits multiple use of components already existing on the vehicle, i.e. both for a particular existing system (e.g. a parking assistance system) as well as for the optical detection system having adjustable camera optics.

The sensors may be ultrasonic, radar and/or infrared sensors. The signals which can be produced by these sensors, can be transmitted to the control device for evaluation to control the focus and/or the image frame of the camera optics.

Alternatively and/or additionally, the signal transmitter may also be formed by a pattern or image detection device. Such an embodiment is suitable e.g. when the vehicle has a system for early detection of accident situations, e.g. a stereo camera system. The image information obtained from the stereo camera system or from individual camera elements can be evaluated by a pattern or image detection device to generate corresponding signals which are transmitted to the control device for the camera optics. The control device can use these incoming signals to control the focus and/or the image frame of the camera optics.

The pattern or image detection device may also be part of a system for early detection of accident situations, e.g. to be able to control further devices such as e.g. braking systems, e.g. when a dangerous situation has been detected in front of the vehicle.

A further development of the invention comprises a display unit which is coupled to the camera optics and/or to the control device. Such a display unit may e.g. be formed by a color monitor integrated in the dashboard of the motor vehicle, and optionally also serves as display unit for navigation systems or multi media devices. When the camera optics and the display unit are directly coupled, the optical detection system can project an image of the surroundings of the vehicle on the display unit. The camera optics can alternatively or additionally be coupled to the control device such that the image information obtained from the camera optics and/or the information obtained from further sensors can be processed, e.g. to be able to add additional image elements such as warning arrows or distance diagrams on the display unit.

The camera optics may be arranged in the rear region or in the front region of the vehicle. If only one single camera optics is provided, it is advantageously disposed in the central region of the vehicle to detect image information of the surroundings of the vehicle from as central a position as possible. When several camera optics are used, they are advantageously positioned to produce a detecting region of maximum size. This is possible e.g. through arrangement of the camera optics within or proximate to the headlight housing.

One embodiment of the invention is advantageous, wherein the camera optics can be pivoted about or displaced along one or more axes of the device. The camera optics can basically be adjusted with six degrees of freedom. To reduce costs and/or weight and/or space, pivoting and/or displacement of the camera optics with less than six degrees of freedom may be desired.

The image frame can be selected through displacement and/or pivoting of the camera optics. To be able to show persons and/or objects in a certain image frame with minimum distortion and high resolution or sharpness, the focus of the camera optics can also advantageously be adjusted. The focus of the camera optics can be physically adjusted through adjustment of the separation between lens and projection surface of the camera optics as well as through digital processing, should digital cameras be used.

The invention also concerns a control device for an optical detection system for vehicles, in particular motor vehicles, which can control the focus and/or the image frame of a camera optics and which is suitable for arrangement on a vehicle, wherein the control device is or can be coupled to a signal transmitter such that the camera optics can be controlled in dependence on signals generated by sensors. The control device may also be provided as a self-contained unit, e.g. for retrofitting used cars or vehicles.

The invention also relates to a method for optical detection which is characterized in that the focus of a camera optics is reduced when the vehicle approaches an object in the vicinity of the vehicle such that the detected image frame is enlarged to detect the entire object or substantial parts thereof. If e.g. the vehicle backs up towards an obstacle, the focus of the camera optics is reduced such that the obstacle can be detected completely or at least substantial portions thereof even when the vehicle comes very close. This would not be possible without adjusting the focus. Adjustment of the focus of the camera optics in this connection means physical adjustment of the focus in conventional camera systems and digital adjustment of the focus in digital cameras.

The invention also relates to a method for optical detection which is characterized in that a camera optics is pivoted and/or displaced in the vicinity of the vehicle when a vehicle approaches an object such that the entire object or substantial parts thereof can be detected. If there is an obstacle in the form of a post offset from the center of the vehicle behind a car backing into a parking space, a camera optics provided in the center of the vehicle can be pivoted such that the post remains within the detected image region even when the vehicle comes very close to it. This image region can be displayed in the above-discussed display unit.

Of course, the above-mentioned methods can also be combined, such that when a vehicle approaches an object, the focus of the camera optics is reduced in the vicinity of the vehicle and the camera optics itself is also pivoted and/or displaced.

Further advantageous embodiments and details of the invention can be extracted from the following description which describes and explains the invention in more detail with reference to the embodiment shown in the drawing.

### BRIEF DESCRIPTION OF THE DRAWING

FIG. 1 shows a schematic view of an inventive optical detection system in accordance with a first embodiment; and

FIG. 2 shows a schematic view of an inventive optical detection system in accordance with a second embodiment.

### DESCRIPTION OF THE PREFERRED EMBODIMENT

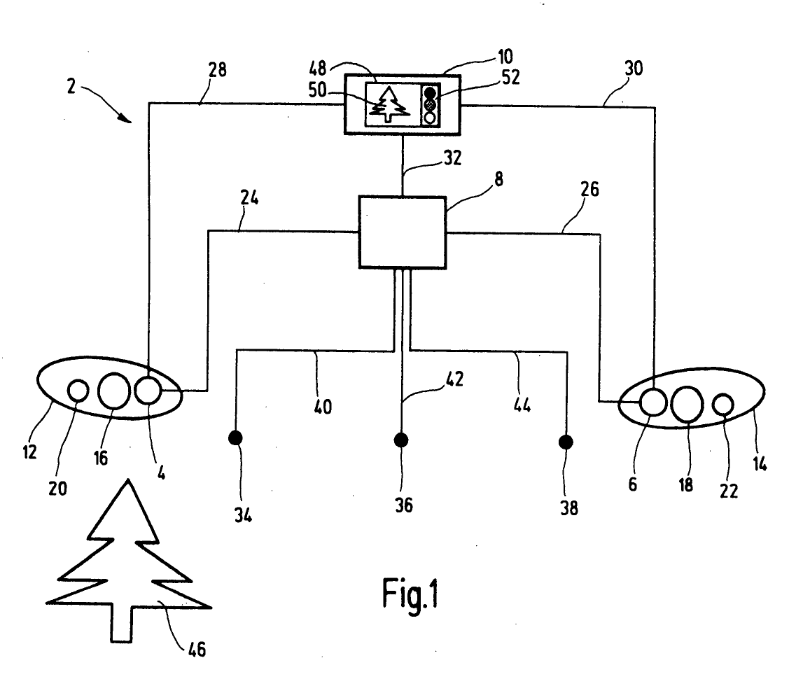

FIG. 1 schematically shows an inventive optical detection system, generally designated by reference numeral 2, comprising two camera optics 4 and 6, one control device 8 and one display unit 10. The camera optics 4 and 6 are integrated in the schematically illustrated headlight housings 12 and 14, which are part of the front region of a vehicle (not shown). The headlight housings 12 and 14 also contain the actual headlights 16 and 18 and indicators 20 and 22.

The camera optics 4 and 6 can be adjusted with respect to focus and/or image frame and are connected to the control device 8 via data lines 24 and 26. The camera optics 4 and 6 are also connected to the display unit 10 via data lines 28 and 30. The control device 8 is connected to the display unit 10 via data line 32.

Three ultrasonic sensors 34, 36 and 38 are also provided, which are integrated in the bumper of the vehicle (not shown) and connected to the control device 8 via data lines 40, 42 and 44.

The illustrated detection system 2 permits detection of objects in the surroundings of the vehicle. For example, the camera optics 4 generates image information of a tree 46 located in the vicinity of the vehicle and the image information is transmitted to the display unit 10 via the data line 28. The display unit 10 has an image region 48 which displays an image 50 of the tree 46. The driver of the vehicle thereby obtains direct information about the type and size of the obstacle in the vicinity of the vehicle, in the present case, of the tree 46.

The tree 46 can also be detected by one or more of the ultrasonic sensors. Corresponding signals can be transmitted to the control device 8 via data lines 40, 42 or 44. If the vehicle approaches the tree 46, the focus and/or the image frame of the camera optics 4 and/or 6 can be adjusted in that the control device 8 transmits corresponding control signals to the camera optics 4 and/or 6 via the data lines 24 and 26. Even when the vehicle moves close to the tree 46, it nevertheless can be completely illustrated, or at least in large parts, in the image region 48 of the display unit 10 through adjustment of the focus and/or the image frame of the camera optics 4 and/or the camera optics 6.

The signals obtained from the ultrasonic sensors 34, 36 or 38 and transmitted to the control device 8 via data lines 40, 42, 44 can also be evaluated to display, via data line 32, graphical elements in an additional field 52 of the display unit 10, to show the driver the distance from the obstacle 46. Corresponding optional or additional acoustic warning signals can, of course, be issued.

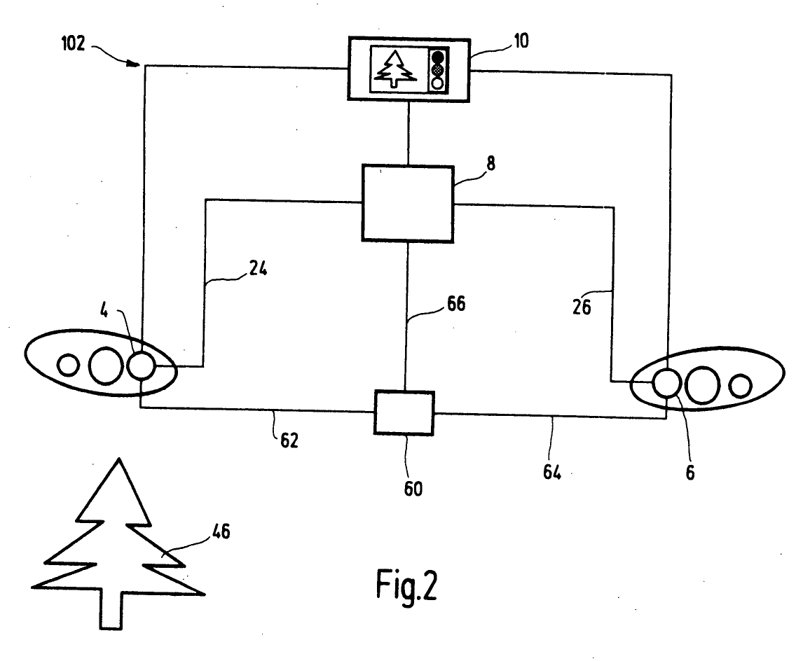

Many components of the optical detection system 102 shown in FIG. 2 correspond to the detection system 2 described in FIG. 1. Camera optics 4 and 6, a control device 8 and a display unit 10 are provided. In contrast to FIG. 1, a image detection device 60 is additionally provided, which is connected to the camera optics 4 or the camera optics 6 via data lines 62 and 64. The image detection device 60 is also connected to the control device 8 via data line 66.

The camera optics 4 and 6 detect obstacles in the vicinity of the vehicle, i.e. the tree 46. The image information obtained thereby can be transmitted to the image detection device 60 via data lines 62 and 64, which, in turn, processes that image information and transmits corresponding signals to the control device 8 via the data line 66. The control device 8 can control the camera optics 4 or 6 via data lines 24 and 26, with respect to focus and/or image frame in dependence on the signals transmitted from the image detection device 60.

If the image detection device 60 detects an enlargement of the obstacle 46, e.g. through comparison of two sequential image information parts, this information can be transmitted via the data line 66 to the control device which can control the camera optics 4 via the data line 24 such that the focus is reduced and the obstacle 46 can still be detected completely or at least partially, even when the vehicle is directly proximate to the obstacle 46.

We claim:

1. An optical detection system for vehicles, comprising:
a camera optics disposed on the vehicle;
a control device communicating with said camera optics for controlling at least one of a focus and an image frame of said camera optics; and
a signal transmitter for generating and communicating signals to said control device, wherein said camera optics is controlled in dependence on said signals.

2. The optical detection system of claim 1, wherein the vehicle is a motor vehicle.

3. The optical detection system of claim 1, wherein said signal transmitter comprises sensors disposed on the vehicle to detect objects in a vicinity of the vehicle.

4. The optical detection system of claim 3, wherein said sensors are part of at least one of a parking assistance system, a distance control system, a lane deviation warning system, a night vision system, and a system for early detection of accident situations.

5. The optical detection system of claim 3, wherein said sensors are at least one of ultrasonic, radar, and infrared sensors.

6. The optical detection system of claim 1, wherein said signal transmitter comprises a pattern or image detection device.

7. The optical detection system of claim 1, further comprising a display unit coupled to at least one of said camera optics and said control device.

8. The optical detection system of claim 1, wherein said camera optics is disposed in a rear region of the vehicle.

9. The optical detection system of claim 1, wherein said camera optics is disposed in a front region of the vehicle.

10. The optical detection system of claim 1, wherein said camera optics can be pivoted about and/or displaced along one or more device axes thereof.

11. A control device in an optical detection system for vehicles, the optical detection system having a camera optics disposed on the vehicle and a signal transmitter for generating and communicating signals to the control device, with the camera optics being controlled in dependence on said signals, wherein the control device comprises means for communicating with the camera optics to control at least one of a focus and an image frame of the camera optics.

12. A method for operating the optical detection system of claim 1, wherein, when the vehicle approaches an object in a vicinity of the vehicle, said focus of said camera optics is reduced such that said image frame is enlarged to detect the entire object or substantial parts thereof.

13. A method for operating the control device of claim 11, wherein, when the vehicle approaches an object in a vicinity of the vehicle, the focus of the camera optics is reduced such that the image frame is enlarged to detect the entire object or substantial parts thereof.

14. A method for operating the optical detection system of claim 1, wherein, when the vehicle approaches an object in a vicinity of the vehicle, said camera optics is pivoted and/or displaced to permit detection of the entire object or of substantial parts thereof.

15. A method for operating the control device of claim 11, wherein when the vehicle approaches an object in a vicinity of the vehicle, the camera optics is pivoted and/or displaced to permit detection of the entire object or of substantial parts thereof.

16. A method for operating the optical detection system of claim 1, wherein, when the vehicle approaches an object in a vicinity of the vehicle, said focus of said camera optics is reduced and said camera optics is pivoted and/or displaced.

17. A method for operating the control device of claim 11, wherein, when the vehicles approaches an object in a vicinity of the vehicle, the focus of the camera optics is reduced and the camera optics is pivoted and/or displaced.

18. A method for operating the optical detection system of claim 1, through operation of said camera optics, through operation of said control device to control said focus and/or said image frame of said camera optics, and through operation of said signal transmitter, wherein said focus and/or said image frame of said camera optics is controlled in dependence on said signals generated by said signal transmitter.
